(19) United States
(12) Patent Application Publication
(10) Pub. No.: US 2012/0117472 A1
(43) Pub. Date: May 10, 2012

(54) Systems and Methods for Application of Special Effects to a Captured Video Stream

(75) Inventor: Chun-Chia Su, Taipei City (TW)

(73) Assignee: CYBERLINK CORP., Shindian City (TW)

(21) Appl. No.: 12/943,393

(22) Filed: Nov. 10, 2010

(51) Int. Cl. G06F 3/01

(52) U.S. Cl. 715/719

(57) ABSTRACT

A method is implemented in a computing system for controlling the application of special effects to a video stream. The method comprises identifying applications requesting access to the video stream and retrieving identifiers associated with each of the applications requesting access. Based on the identifiers, a query operation is performed to obtain information relating to the applications. The method further comprises receiving a selection of one or more applications associated with the identifiers. Based on the selection, a version of the video stream is routed to each application.

### TECHNICAL FIELD

The present disclosure generally relates to systems and methods for applying special effects such as webcam effects to a video stream.

### BACKGROUND

Over the years, video capture devices such as webcams have become a popular means of communications, and live video communication over the Internet has become common among users around the world. Such programs as Windows Live Messenger® and Skype® allow users to engage in live, face-to-face conversations. The integration of special effects into video streams generated from webcams is a common feature for webcam programs. Programs are available that allow users to enhance webcam sessions by incorporating such special effects as graphics and augmented reality effects.

Many webcam interfaces allow the same captured video stream to be shared among different applications. For example, an instant messaging application and a security monitoring application might both share video captured by a common webcam device. In conventional setups, once special effects are enabled, these effects are applied to all applications receiving the webcam video feed, thereby limiting the user to an all or nothing configuration. One perceived shortcoming with such configurations is that special effects may not be needed for all applications. For example, a security monitoring application may focus on facial recognition, so special effects are generally not needed and may in fact, affect the facial recognition process. On the other hand, for instant messaging applications, the user may want to incorporate graphics on or around the individual captured on a webcam to enhance the instant messaging sessions.

### SUMMARY

Briefly described, one embodiment, among others, is a method implemented in a computing system for controlling the application of special effects to a video stream. The method comprises identifying applications requesting access to the video stream and retrieving identifiers associated with each of the applications requesting access. Based on the identifiers, a query operation is performed to obtain information relating to the applications. The method further comprises receiving a selection of one or more applications associated with the identifiers. Based on the selection, a version of the video stream is routed to each application. In accordance with such embodiments, the version of the video stream comprises the video stream unmodified and the video stream with integrated special effects.

Another embodiment is a method that comprises generating a special effects version of the video stream, retrieving identifiers associated with applications requesting access to display the video stream, and receiving a selection of one or more of the identifiers through a user interface listing each of the applications. Based on the selection, either the special effects version or an unmodified version of the video stream is routed to each application.

Another embodiment is a system that comprises a splitter for interfacing with applications for providing a video stream and for identifying applications that are requesting access to the video stream. The system further comprises a video stream management application configured to receive process identifiers associated with the identified applications. In accordance with such embodiments, the video stream management application further comprises a special effects module for integrating special effects into the video stream to create a special effects version of the video stream. The video stream management application is further configured to provide a user interface to an output device in the system based on the process identifiers to receive a selection of one or more of the applications. Based on the selection, the splitter routes either the special effects version of the video stream or an unmodified version of the video stream to each application.

Another embodiment is a non-transitory computer readable medium, configured for controlling the transmission of special effects, the computer readable medium storing a program that, when executed by a computer, causes the computer to perform the operations of generating a special effects version of a video stream captured on a webcam, retrieving identifiers associated with applications requesting access to display the captured video stream, and displaying a user interface and receiving a selection of one or more of the applications associated with the retrieved identifiers. Based on the selection, either the special effects version or an unmodified version of the video stream is routed to each application.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 depicts a top-level diagram of a video system for controlling the transmission of a captured video stream in accordance with various embodiments.

FIG. 2 illustrates additional components of the video system shown in FIG. 1.

FIG. 3A illustrates the splitter of the video system in FIG. 1 obtaining process identifiers associated with applications requesting access to the captured video stream.

FIG. 3B illustrates the splitter forwarding the process identifiers to the video stream management application.

FIG. 3C illustrates the use of a graphical user interface for receiving a user's selection(s).

FIG. 3D illustrates the creation of a special effects version of the captured video stream.

FIG. 3E illustrates each application displaying a version of the captured video stream based on the selection(s) of the user.

FIG. 4 is a flowchart illustrating a process for controlling the transmission of a captured video stream implemented in the video system of FIG. 1.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

Various embodiments are described for efficiently controlling the application of webcam effects across different applications which share the video/audio stream generated by a video capture device such as a webcam. As described, one perceived shortcoming with conventional setups is that once webcam effects are enabled, these effects are applied to all applications receiving the webcam video feed, thereby limiting the user to an all or nothing configuration with respect to special effects.

Exemplary embodiments provide users with the flexibility of deciding which applications receive a webcam feed with special effects and which applications receive an unmodified webcam feed, thereby allowing users to execute multiple applications at the same time with full control over the integration of special effects. Systems and methods are described for enabling webcam effects in a splitter to provide webcam frames to several applications at the same time. Such embodiments comprise a video stream management application that provides an interactive means for controlling the application of special effects.

For some implementations, a splitter is provided, which retrieves individual process identifiers associated with the applications receiving the webcam stream. These identifiers are forwarded to the video stream management application. For some embodiments, the video stream management application performs a series of queries based on the identifiers, and the detailed information relating to the processes/applications is obtained. Based on this information, a user interface is generated, which provides a user with a means for selecting which applications to receive a special effects version of the captured video stream. Upon receiving the user's selections, the video stream management application forwards the information back to the splitter, which then routes an appropriate stream (either a stream with special effects or a stream without special effects) to each respective application.

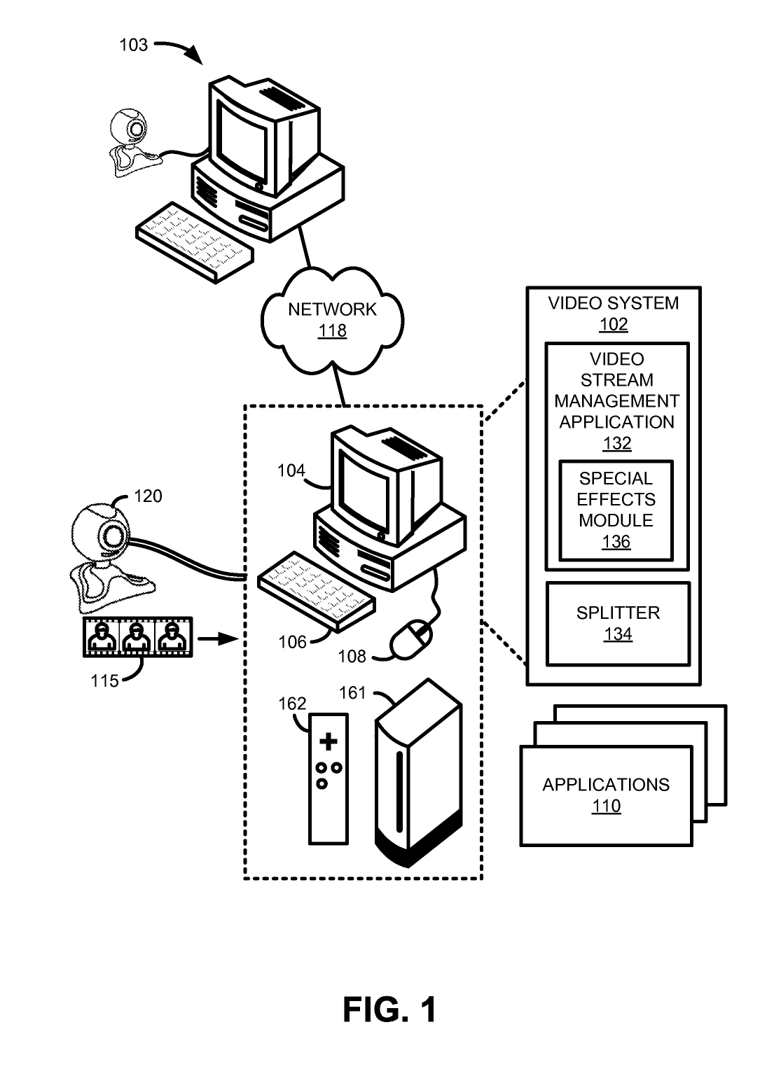

A description of a system for controlling the application of special effects is now described followed by a discussion of the operation of the components within the system. FIG. 1 is a block diagram of an environment in which embodiments of a video system 102 may be implemented. The video system 102 that may be embodied, for example, as a desktop computer, computer workstation, laptop, or other computing platform. In other embodiments, the video system 102 may be embodied as, but is not limited to, a video gaming console 161, which includes a video game controller 162 for receiving user preferences. For such embodiments, the video gaming console 161 may be connected to a television (not shown) or other display.

The video system 102 includes a display 104 and input devices such as a keyboard 106 and a mouse 108. The video system 102 comprises a splitter 134 and a video stream management application 132, where the video stream management application 132 further comprises a special effects module 136. The video stream management application 132 is configured to interface with a webcam 120 coupled to the video system 102 and receive a video stream 115 from the webcam 120. For some embodiments, the webcam 120 is connected to the network 118 such that the video system 102 receives a video stream 115 from a network-connected video capturing device. The splitter 134 may be implemented in software, hardware, or a combination of both software and hardware for providing a video stream. As described in more detail later, when implemented in software, the splitter 134 is embodied as a program or virtual driver stored on a non-transitory computer readable medium and executed by a processor on a computing system. When embodied in hardware, the splitter 134 may be implemented in the form of a physical driver.

For embodiments where the splitter 134 is embodied as a program or virtual driver, the splitter 134 may be implemented as a driver for a capture device such as the webcam 120 shown in FIG. 1. In accordance with such embodiments, the splitter 134 is configured to execute in various operating systems (OS), including but not limited to, Windows®, Linux®, Unix®, and Mac OS®. The splitter 134 may also be incorporated into smartphones and configured to operate on the Android® or iOS® operating systems. When operating in Windows®, the splitter 134 is implemented as a video capture source filter in the Microsoft DirectShow® framework. In Windows®, a capture device is represented in Microsoft Media Foundation as a media source object. In Linux®, the splitter 134 may be implemented as a capture source component in the GStreamer framework. In the Android® operating system, the splitter 134 may be implemented as a capture source component in the OpenMax framework. In the iOS® operating system, the splitter 134 may be implemented as part of the AVCaptureDevice class in the AVFoundation framework.

For some embodiments, the video stream management application 132 is configured to receive a captured video stream from the webcam 120. As shown in FIG. 1, the splitter 134 further comprises a special effects module 136 for integrating special effects into the captured video stream to create a special effects version of the captured video stream. The video stream management application 132 is configured to identify applications 110 currently executing on the video system 102 requesting access to the captured video stream. As described in more detail in connection with the figures that follow, the video stream management application 132 is further configured to retrieve identifiers associated with each of the applications 110 requesting access.

The video stream management application 132 generates a user interface displayed on the display 104 in the video system 102, which allows users to select applications which receive a modified (or unmodified) version of the captured video stream, where the modified version comprises a special effects version generated by the special effects module 136 described earlier. Based on the user's selection(s), the splitter 134 routes either the special effects version of the captured video stream or an unmodified version of the captured video stream to each application 110. The video system 102 in FIG. 1 may be coupled to a network 118, such as the Internet or a local area network (LAN). Through the network 118, the video system 102 may receive a video stream 115 from another video system 103. Utilizing the components described above, the video system 102 provides the user an effective way to manage and control the integration of special effects into applications sharing a common video capture device.

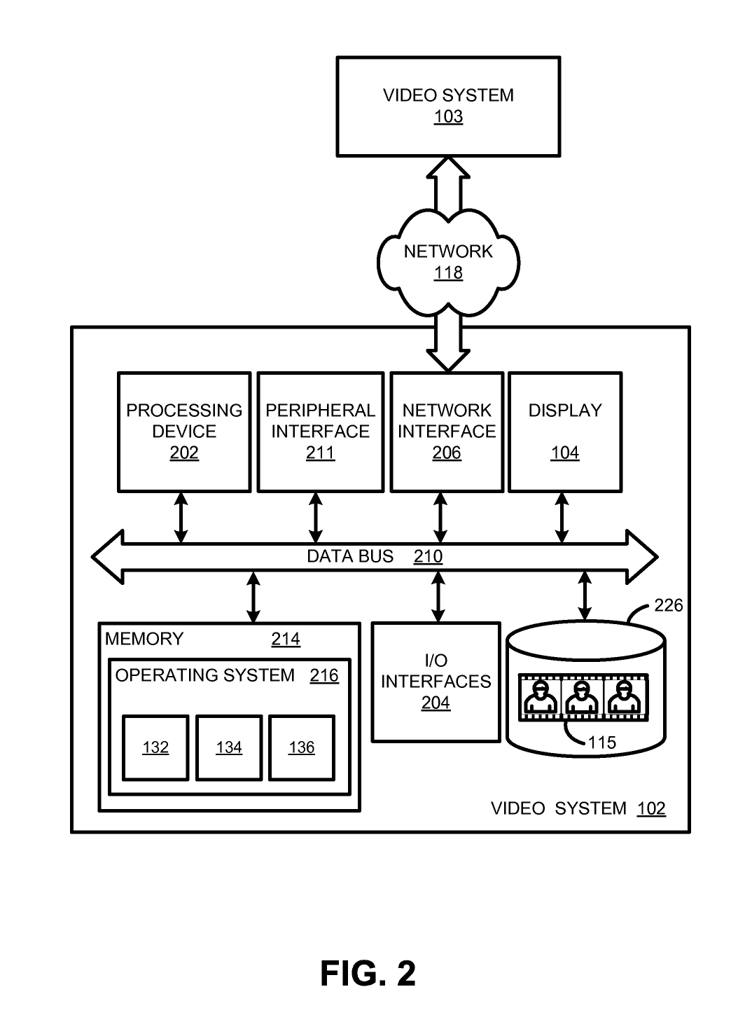

FIG. 2 illustrates an embodiment of the video system 102 shown in FIG. 2. The video system 102 may be embodied in any one of a wide variety of wired and/or wireless computing devices, such as a desktop computer, portable computer, dedicated server computer, multiprocessor computing device, smartphone, personal digital assistant (PDA), digital camera, and so forth. As shown in FIG. 2, the video system 102 comprises a memory 214, a processing device 202, a number of input/output interfaces 204, a network interface 206, a display 104, a peripheral interface 211, and mass storage 226, wherein each of these devices are connected across a local data bus 210.

The processing device 202 may include any custom made or commercially available processor, a central processing unit (CPU) or an auxiliary processor among several processors associated with the video system 102, a semiconductor based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system.

The memory 214 can include any one of a combination of volatile memory elements (e.g., random-access memory (RAM, such as DRAM, and SRAM, etc.)) and nonvolatile memory elements (e.g., ROM, hard drive, tape, CDROM, etc.). The memory 214 typically comprises a native operating system 216 (which may include but is not limited to, Microsoft® operating systems, Linux® operating system, Unix® operating systems, Apple® operating systems, and Google Android®), one or more native applications, emulation systems, or emulated applications for any of a variety of operating systems and/or emulated hardware platforms, emulated operating systems, etc. For example, the applications may include application specific software which may comprise some or all the components 132, 134, 136 of the video system 102 depicted in FIG. 1. In accordance with such embodiments, the components are stored in memory 214 and executed by the processing device 202. One of ordinary skill in the art will appreciate that the memory 214 can, and typically will, comprise other components which have been omitted for purposes of brevity.

Input/output interfaces 204 provide any number of interfaces for the input and output of data. For example, where the video system 102 comprises a personal computer, these components may interface with one or more user input devices through the input/output interfaces 204 of the video system 102, where the input devices may comprise a keyboard 106 and/or a mouse 108, as shown in FIG. 1. The display 104 may comprise a computer monitor, a plasma screen for a PC, a liquid crystal display (LCD) on a hand held device, or other display device.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

In this regard, one embodiment is a non-transitory computer readable medium, configured for controlling the transmission of special effects. The computer readable medium stores a program that, when executed by a computer, causes the computer to perform the operations of generating a special effects version of a video stream captured on a webcam, retrieving identifiers associated with applications requesting access to display the captured video stream, and displaying a user interface and receiving a selection of one or more of the applications associated with the retrieved identifiers. Based on the selection, either the special effects version or an unmodified version of the video stream is routed to each application.

With further reference to FIG. 2, the network interface 206 comprises various components used to transmit and/or receive data over a network environment. For example, the network interface 206 may include a device that can communicate with both inputs and outputs, for instance, a modulator/demodulator (e.g., a modem), wireless (e.g., radio frequency (RF)) transceiver, a telephonic interface, a bridge, a router, network card, etc.). As shown in FIG. 2, the video system 102 may communicate with one or more video systems 103 via the network interface 206 over the network 118. The video system 102 may further comprise mass storage 226 which stores such data as a video stream 115. The peripheral interface 211 supports various interfaces including, but not limited to IEEE-1394 High Performance Serial Bus (Firewire), USB, a serial connection, and a parallel connection.

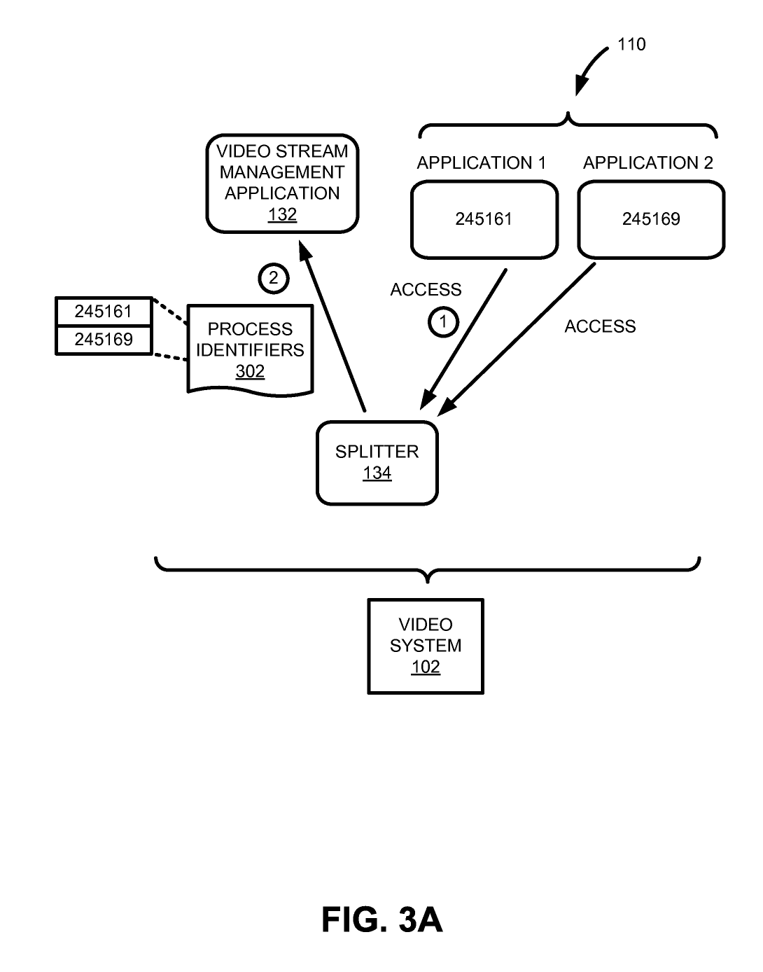

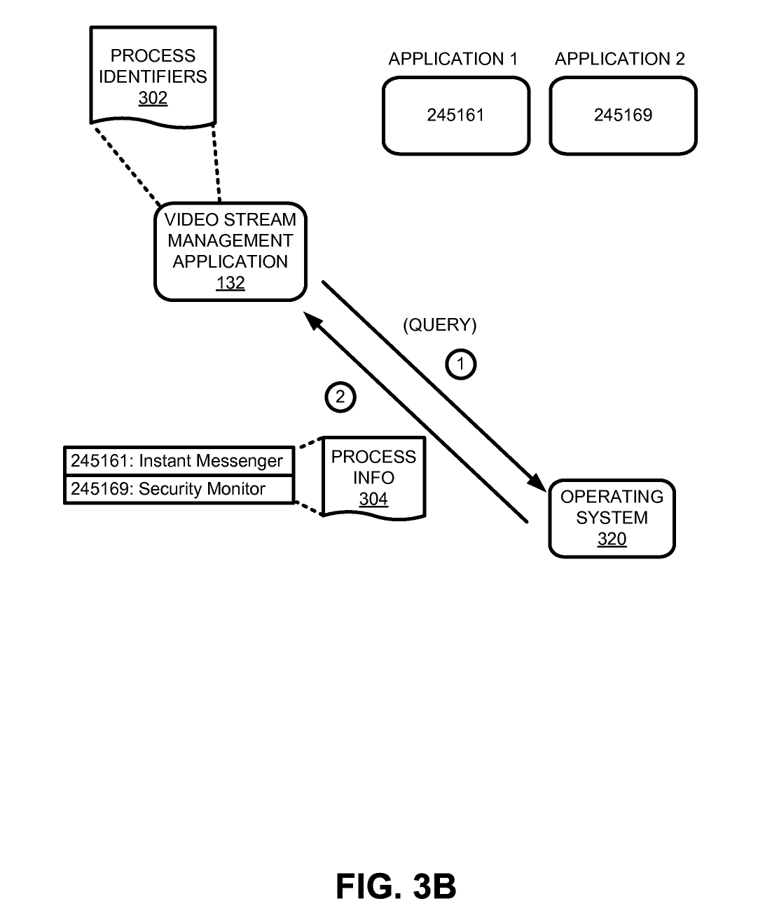

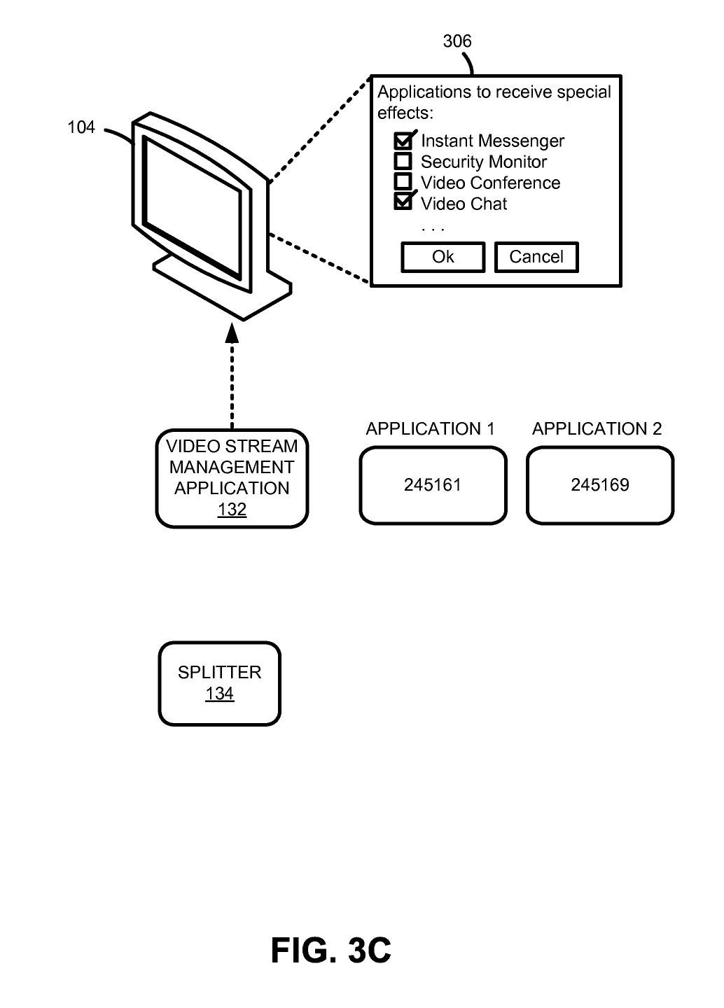

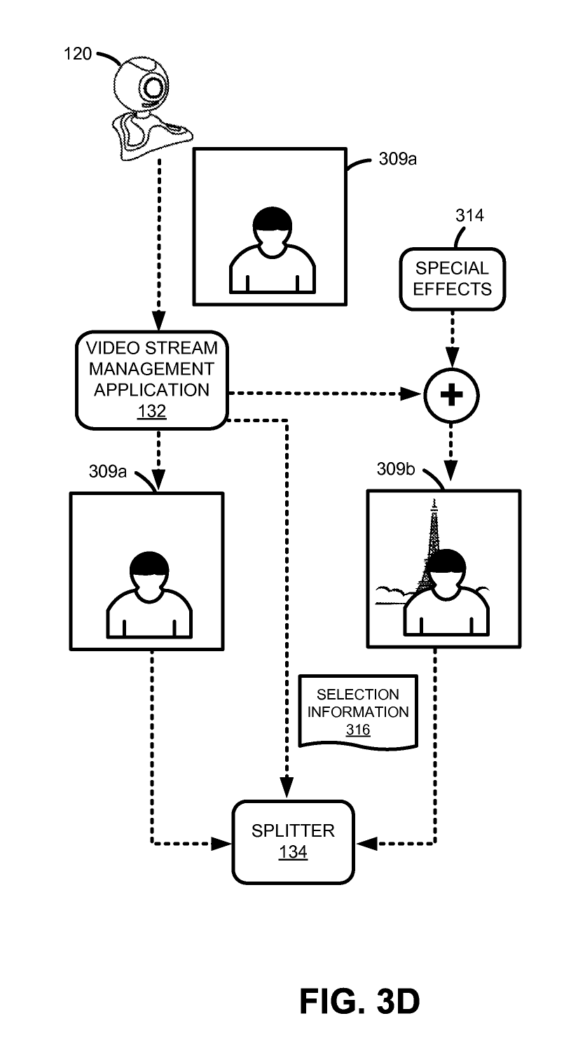

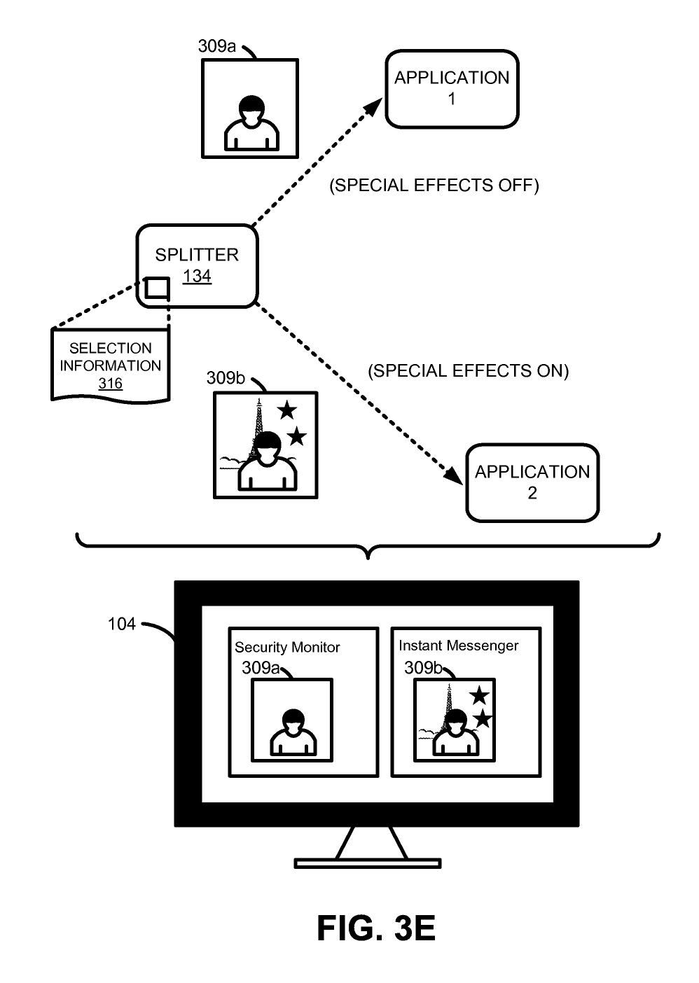

Reference is now made to FIGS. 3A-3E, which illustrate the process flow among the components shown in the video system 102 of FIG. 1. Beginning in FIG. 3A, when applications (Application 1 and Application 2) request access to video captured by the webcam 120 of FIG. 1, the splitter 134 obtains process identifiers 302 associated with the applications. For purposes of illustration, Application 1 is associated with process identifier “245161” and Application 2 is associated with process identifier “245169.” These process identifiers 302 are sent by the splitter 134 to the video stream management application 132.

With reference to FIG. 3B, the video stream management application 132 then queries the operating system 320 based on the received process identifiers 302. In response, the operating system 320 sends process information 304 associated with the process identifiers 302. As shown in the non-limiting example, for some embodiments, such process information 304 may include, but is not limited to, the names of the applications. The process information 304 may also comprise a unique identifier assigned to each respective application, the manufacturer's name, the version number of the application, and so on. As shown in FIG. 3B, process identifier “245161” is associated with the application “Instant Messenger.” Similarly, process identifier “245169” is associated with the application “Security Monitor.” In some implementations, these names retrieved from the operating system 320 are used for generating a user interface, as will be described in more detail below.

Turning now to FIG. 3C, the video stream management application 132 renders a user interface 306 on the display 104 of the video system 102. As illustrated in the non-limiting example, the user interface 306 displays a list of all the applications (e.g., Application 1 and Application 2 in the example shown) requesting access to the video stream captured by the webcam 120. A selection means allows the user to select applications and may comprise check boxes, combo boxes, a drop-down list, radio buttons, a context menu, among other selection controls. For some embodiments, the user interface displays all the applications, and a default selection is assigned for each application based on the information obtained for each application. For example, the video stream management application 132 may determine that a security monitor will generally not incorporate special effects. Therefore, the corresponding selection field may be left unchecked by default. On the other hand, the selection field for an instant messaging program such as Windows Live Messenger® and Skype® may be checked by default. This may be implemented based on a predetermined list of commonly used applications.

For some embodiments, the video stream management application 132 is configured to automatically generate the user interface when a new application requesting access to the captured video stream is initiated in the video system 102. For example, if the user initiates an instant messaging session, the video stream management application 132 automatically generates a user interface to prompt the user on whether the instant messaging session should receive a special effects version of the captured video stream. Alternatively, the user can also launch the user interface to change a previous selection. For example, the user may later decide to conduct an instant messaging session without special effects and may therefore want to turn off or remove the special effects. For such embodiments, the user launches the user interface via an input/output device such as the mouse 108 shown in the video system 102 of FIG. 1 and simply unselects the previously-selected instant messaging application.

In the illustration shown in FIG. 3C, the user selects the “Instant Messenger” and “Video Chat” applications to receive the captured video stream with integrated special effects. As the other applications (i.e., “Security Monitor” and “Video Conference”) are not selected, these applications will receive an unmodified version of the captured video stream, as described more detail below. Turning now to FIG. 3D, using the special effects module 136 shown in the video system 102 of FIG. 1, the video stream management application 132 generates a modified version of the video captured by the webcam 120. This modified version comprises the captured video with special effects 314 integrated into the video stream. Special effects may include by way of example and without limitation: moving graphics, customized text, customized subtitles, embedded video, and transition effects. The modified version and an unmodified version of the captured video stream are then forwarded by the video stream management application 132 to the splitter 134. The video stream management application 132 also forwards the user's selection received via the user interface shown in FIG. 3C to the splitter 134.

As shown in FIG. 3E, the splitter 134 routes either an unmodified version 309a or modified version 309b of the captured video stream to each application. The version that is routed is based on the selection information 316 received from the video stream management application 132 shown in FIG. 3D. As shown, the output of each application (Application 1 and Application 2) is shown on the display 104 of the video system 102. Through the exemplary embodiments disclosed above, the user can therefore execute multiple applications at the same time and control which applications display the captured video stream with integrated special effects.

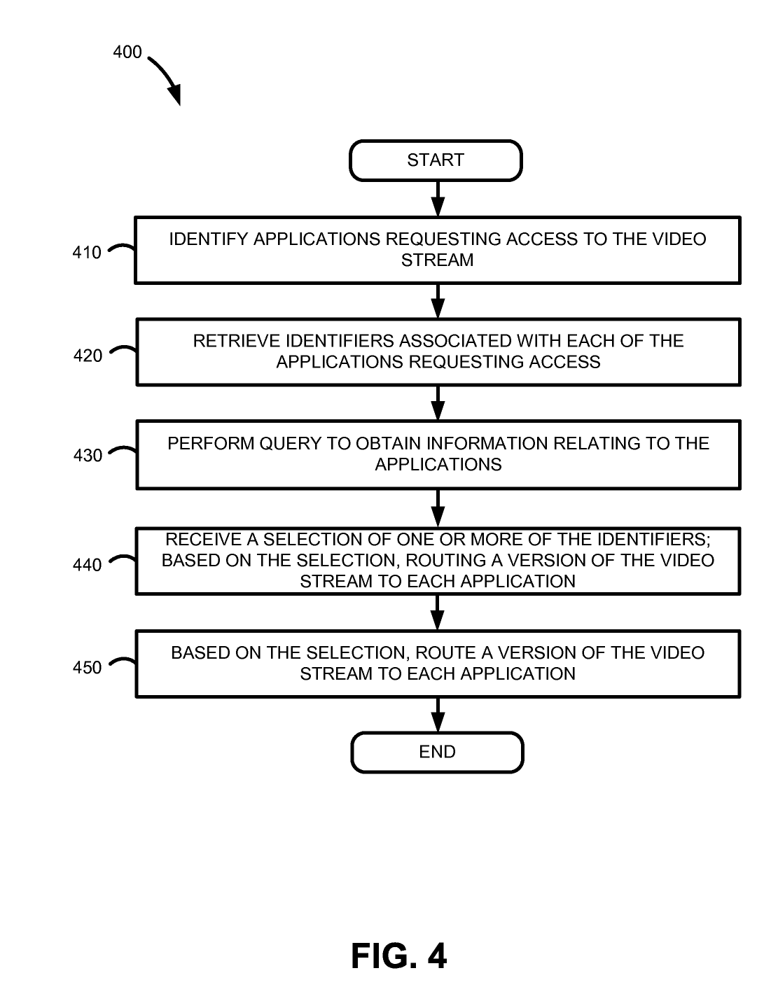

FIG. 4 is a flowchart 400 illustrating a process for controlling the transmission of a captured video stream implemented in the video system 102 of FIG. 1. If embodied in software, each block depicted in FIG. 4 represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as a processor in a computer system or other system such as the one shown in FIG. 1. The machine code may be converted from the source code, etc. If embodied in hardware, each block may represent a circuit or a number of interconnected circuits to implement the specified logical function(s).

Although the flowchart 400 of FIG. 4 shows a specific order of execution, it is understood that the order of execution may differ from that which is depicted. Beginning with block 410, applications requesting access to the video stream are identified. As described earlier, such applications may include, by way of illustration, a security monitor application and an instant messaging application. In block 420, process identifiers associated with each of the applications requesting access to the video stream are retrieved. As discussed in connection with FIG. 3A, the retrieval of process identifiers is performed by the splitter 134.

The video stream management application 132 performs a query to obtain additional information relating to the applications (block 430). In block 440, a selection of one or more of the applications associated with the retrieved identifiers is received. As illustrated in FIG. 3C, this may be performed via a graphic user interface rendered on the display 104 of the video system 102. Based on the one or more selections by the user, a version of the video stream is routed to each application (block 450). Specifically, either a special effects version of the video stream or an unmodified version of the video stream is routed to each application based on the selection made in block 440.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A method implemented in a computing system for controlling the application of special effects to a video stream, the method comprising:
identifying applications requesting access to the video stream;
retrieving identifiers associated with each of the applications requesting access;
based on the identifiers, querying to obtain information relating to the applications;
receiving a selection of one or more applications associated with the identifiers; and
based on the selection, routing a version of the video stream to each application, wherein the version of the video stream comprises:
the video stream unmodified; and
the video stream with integrated special effects.

2. The method of claim 1, wherein the identifiers are assigned by an operating system executing on the computing system.

3. The method of claim 1, further comprising generating a user interface, wherein the user interface comprises means for selecting one or more of the applications for applying the version of the video stream to the selected one or more applications.

4. The method of claim 3, wherein a default selection for each application is displayed based on the information obtained for each application.

5. The method of claim 4, wherein the default selection for each application is based on a predetermined list of applications.

6. The method of claim 3, wherein generating the user interface is performed upon initiation of one or more new applications, wherein the user interface lists the one or more new applications.

7. The method of claim 3, wherein generating the user interface is initiated by a user of the computing system.

8. The method of claim 1, wherein the video stream is generated by a webcam.

9. The method of claim 1, wherein the video stream is transmitted from a network-connected video capturing device.

10. The method of claim 1, further comprising in response to additional applications being initiated, retrieving identifiers associated with each of the applications requesting access.

11. A method implemented in a computing system for controlling the application of special effects to a video stream, the method comprising:
generating a special effects version of the video stream;
retrieving identifiers associated with applications requesting access to display the video stream;
receiving a selection of one or more of the identifiers through a user interface listing each of the applications; and
based on the selection, routing either the special effects version or an unmodified version of the video stream to each application.

12. The method of claim 11, wherein the identifiers are assigned by an operating system executing on the computing system.

13. The method of claim 11, further comprising repeating the operations of generating, retrieving, receiving, and routing when a new application requesting access to the video stream is initiated, wherein the operations are performed with existing applications and the new application.

14. The method of claim 11, wherein receiving a selection of one or more of the identifiers is initiated by a user of the computing system via an input device coupled to the computing system.

15. A system, comprising:
a splitter for interfacing with applications for providing a video stream and for identifying applications requesting access to the video stream; and
a video stream management application configured to receive process identifiers associated with the identified applications, the video stream management application further comprising a special effects module for integrating special effects into the video stream to create a special effects version of the video stream, the video stream management application further configured to provide a user interface to an output device in the system based on the process identifiers to receive a selection of one or more of the applications,
wherein based on the selection, the splitter routes either the special effects version of the video stream or an unmodified version of the video stream to each application.

16. The system of claim 15, wherein the video stream management application is further configured to generate the user interface when a new application requesting access to the video stream is initiated in the system.

17. The system of claim 15, wherein the video stream management application is further configured to query an operating system executing in the system to retrieve information relating to the identified applications, wherein the querying is performed according to the received process identifiers, and wherein the user interface is provided based on the retrieved information.

18. A non-transitory computer readable medium, configured for controlling transmission of special effects, the non-transitory computer readable medium storing a program that, when executed by a computer, causes the computer to perform:
generating a special effects version of a video stream captured on a webcam;
retrieving identifiers associated with applications requesting access to display the captured video stream;
displaying a user interface and receiving a selection of one or more of the applications associated with the retrieved identifiers; and
based on the selection, routing either the special effects version or an unmodified version of the video stream to each application.

19. The non-transitory computer readable medium of claim 18, the program further causing the computer to poll for new applications requesting access to the captured video stream.

20. The non-transitory computer readable medium of claim 19, the program further causing the computer to display the user interface when a new application requesting access to the captured video stream is detected.

21. The non-transitory computer readable medium of claim 18, wherein the identifiers are assigned by an operating system executing on the computing.
